(19) United States
(12) Patent Application Publication
(10) Pub. No.: US 2024/0329283 A1
(43) Pub. Date: Oct. 3, 2024

(54) OPTICAL COMPONENT FOR REDIRECTING LIGHT

(71) Applicant: EDMUND OPTICS, INC., Barrington, NJ (US)

(72) Inventors: Nathan Carlie, Cherry Hill, NJ (US); Lars Sandström, Philadelphia, PA (US); Luigi P. Verdoni, Rocky Hill, NJ (US)

(21) Appl. No.: 18/681,846

(22) PCT Filed: Aug. 9, 2022
(86) PCT No.: PCT/US2022/074714

§ 371 Date: Feb. 6, 2024

Related U.S. Application Data
(60) Provisional application No. 63/231,577, filed on Aug. 10, 2021.

(51) Int. Cl. G02B 5/00; G02B 1/02; G02B 5/08; G02B 7/182

(52) U.S. Cl. CPC G02B 5/003; G02B 1/02; G02B 5/0808; G02B 7/182

(57) ABSTRACT

An optical component includes a substrate, the substrate including a first surface having a surface flatness oOJ4 (peak-valley) wherein the optical component transmits no more than 0.001% of light at 532 nm at an angle of incidence between 45-90°. The substrate is one-piece including no joints, no seams, or any formerly separate pieces, and made of black quartz. The optical component can include a radiation absorbing layer on the substrate, wherein the radiation absorbing layer includes one of tungsten, tungsten carbide, silicon carbide, black chrome, black oxide, and black paint.

### RELATED APPLICATIONS

This application claims the benefit of U.S. Provisional Patent Application No. 63/231,577, filed Aug. 10, 2021, which is hereby incorporated by reference for all purposes as if fully set forth herein.

### FIELD OF DISCLOSURE

The present disclosure relates to an optical component. More specifically, the present disclosure relates to an optical component for high power laser applications that reflects the laser beam and absorbs unwanted stray light.

### BACKGROUND

Certain optical components used in sensitive and high-power laser applications provide multiple reflections. Optical radiation incident on the optical components can reflect in different directions from different surfaces of the optical components. Some of the incident rays of optical radiation will be absorbed by an optical component leading to localized heating. Some of the incident rays will continue to propagate through the entire optical component. Some of the reflections and transmissions are desired and some are not. In high-power laser systems, the energy of the optical radiation is substantial and can present significant problems given the potential damage high-energy laser beams can inflict to equipment and people. A variety of solutions have been used to safely dissipate the optical radiation from stray and unwanted reflections and transmissions through optical components.

Some conventional solutions for directing unwanted optical reflections often require extra processing steps such as polishing the backside of an optical component in a specialized manner to ensure that the unwanted light propagates in a specific direction. Additionally, a wedge can be included between front and back surfaces of an optical component to steer the incident laser beam off axis and avoid creating any optical instabilities via external optical feedback (EOF) that may affect the broader laser cavities performance (output power, linewidth, propagation mode).

Other solutions include depositing polymeric materials, typically black, onto the backside of an optical component to absorb transmitted radiation. These solutions are limited to lower power laser applications because the polymeric materials thermally degrade when subject to higher power radiation and outgas contaminants. Alternatively, different substrate materials for the optical components have been used such as metals to provide better thermal performance. However, such materials are more difficult to polish to an adequate quality for laser applications and often provide substandard reflectivity and surface roughness performance.

Additional solutions include an external absorber that uses a secondary module or component such as a beam dump placed behind the primary optical component to capture the unwanted light. For example, U.S. Pat. No. 10,371,873 describes an arrangement of specially processed and coated glasses to contain and dissipate an unwanted optical beam via repetitive absorption and reflection.

Accordingly, there is a need in the art for a single optical component configuration that can terminate transmitted high-power optical radiation and dissipate unwanted reflections that reduce the optical signal to noise ratio (OSNR) or sensitivity of an entire optical system. Such an optical component should be composed of materials that can absorb high-power optical radiation with minimal thermal expansion, without outgassing, and with degrading over time while allowing for use of conventional polishing techniques to achieve the required surface quality for laser applications.

### SUMMARY

To overcome the problems described above, embodiments of the present disclosure provide an optical device or component that traps and isolates optical power to minimize or eliminate propagation to undesired locations. Such an optical component can be a single-piece structure and fabricated using conventional processing techniques. This approach can reduce cost and component size when integrated into larger optical systems as compared to conventional optical beam dumps.

In an embodiment, an optical component includes a substrate, the substrate including a first surface having a surface flatness of λ/4 (peak-valley) wherein the optical component transmits no more than 0.001% of light at 532 nm at an angle of incidence between 45-90°.

In an embodiment, the substrate is one-piece including no joints, no seams, or any formerly separate pieces, and made of black quartz. The optical component can Include a radiation absorbing layer on the substrate, wherein the radiation absorbing layer includes one of tungsten, tungsten carbide, silicon carbide, black chrome, black oxide, and black paint.

The optical component can further a stem on a second surface of the substrate, wherein the stem protrudes from the second surface. The stem can be made of a same material as the substrate.

In another embodiment, an optical component includes a substrate; and a stacked substrate attached to the substrate, wherein one of the substrate and the stacked substrate includes a surface having a surface flatness of λ/4 (peak-valley), and the optical component transmits no more than 0.001% of light at 532 nm at an angle of incidence between 45-90°.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 illustrates an optical component according to an embodiment of the present disclosure.

FIG. 2 illustrates an optical component according to another embodiment of the present disclosure.

FIG. 3 illustrates an optical component according to another embodiment of the present disclosure.

FIG. 4 illustrates an optical component according to another embodiment of the present disclosure.

FIG. 5 illustrates an optical component according to another embodiment of the present disclosure.

### DETAILED DESCRIPTION

FIG. 1 illustrates an optical component according to one embodiment of the present disclosure. As shown, the optical component can include a substrate 10 with a flat and polished surface 20 (indicated by the dotted line). The substrate material can be a heat-absorbing black fused silica that has been formed to a desired size, shape, and thickness. The substrate 10 can be glass, crystal, ceramic, or any other suitable material. For example, the substrate can be black qauartz. For example, the substrate material can be Heraeus Black Quartz (HBQ®) supplied by Heraeus Quarzglas GmbH & Co. KG (Heraeus Conamic) Kleinostheim, Germany.

The optical component substrate can be fabricated to have any shape and is not limited to circular geometries. The fabrication of the optical component can be performed by either using additive or subtractive methods. For example, subtractive methods can include starting with a mass of raw material and then cutting, grinding, milling, turning, polishing, and the like to create a one-piece “monolithic” substrate that does not include any joints, seams, or formerly separate pieces. For example, additive methods can include gluing or bonding individual pieces together or 3D printing to create a one-piece substrate.

One surface of the optical component can be processed to provide a low and symmetrical force to achieve a surface flatness higher than λ/4 (peak-valley) at the required wavelength. This flat and polished surface 20 of the substrate 10 can be finished using traditional optical manufacturing techniques such as polishing, yielding surface roughness with an RMS>7 Angstroms, and also including super polishing with an RMS of <1 Angstrom. or energetic finishing (e.g., laser finishing, Ion beam finishing, thermal finish “flash polish”) to obtain the extremely smooth surfaces lacking subsurface damage. Once fabricated, the optical component shown in FIG. 1 has reflective and absorptive properties. As such, the optical component reflects optical radiation at wavelengths from the UV into the IR (200 nm-2.3 um), and at normal angle of incidence (AOI) up to 60 degrees (i.e., Brewster's angle) and absorbs optical radiation at wavelengths from the UV into the IR (200 nm-2.3 um), with a measured optical density 5 (OD5) at 532 nm, and at normal angle of incidence (AOI) up to 45 degrees. At this wavelength, only 0.001% ( 1/10,000) of the light will pass through the optical component, with similar behavior expected at wavelengths from the UV into the IR (200 nm-2.3 um).

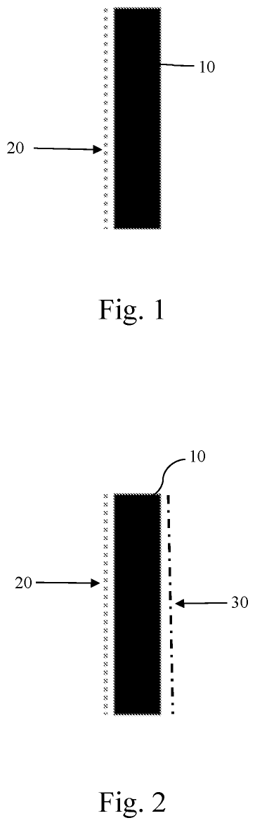

FIG. 2 illustrates an optical component according to another embodiment of the present disclosure. FIG. 2 shows that the optical component of FIG. 1 can further include a radiation absorbing layer 30 (indicated by the dotted and dashed line). The radiation absorbing layer can be Ebonol® C, tungsten, tungsten carbide, silicon carbide, black chrome, black oxide, black paint, or any other suitable material.

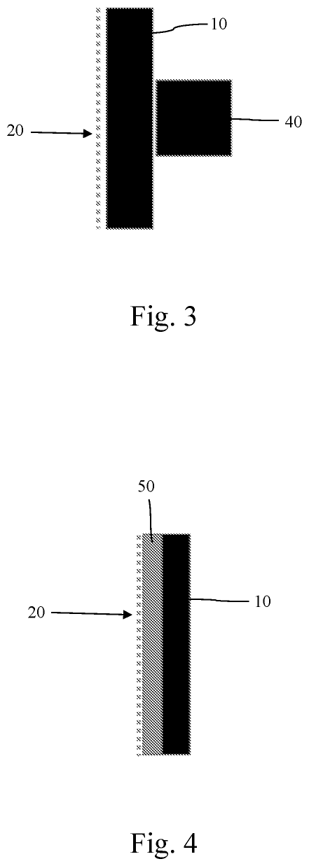

FIG. 3 illustrates an optical component including a stem 40 according to another embodiment of the present disclosure. Because it is understood that physically stresses caused by mounting components in an optical system can cause changes or degradation to optical performance of the mounted component, a stress reduction feature can be included in the optical component. FIG. 3 shows that a stem 40 can be included at a rear surface of the optical component to provide a location for mounting the optical component. Using the stem 40 to mount the optical component in the optical system will reduce the transfer of physical stress to the optical component and minimize optical performance changes or degradation caused by mounting.

FIG. 3 shows the stem 40 on an opposite side of the substrate 10 from the flat and polished surface 20. The stem 40 can be fabricated to be integral with the substrate 10 such that the stem 40 is an extension of the substrate material. Alternatively, the stem 40 can be provided as a separate piece or multiple pieces that can be bonded or attached to the rear of the substrate 10. Although shown as rectangular, the stem 40 can be any shape and size to be suitable and compatible with the optical component, the application, and mounting method. The stem 40 can be made of the same material as the substrate 10 or of any other suitable material or materials.

FIG. 4 illustrates an optical component with a stacked substrate 50 according to another embodiment of the present disclosure. FIG. 4 shows an optical component including a composite architecture with a stacked optical surfaces or layers. The composite architecture includes an additional stacked substrate 50 that is adhered, deposited, cemented, or bonded to the substrate 10. Although indicated as one feature in FIG. 4, the stacked substrate 50 can be any combination of materials, additional substrates, and optical coatings. For example, the stacked substrate 50 can include a transparent material substrate, which possess superior surface quality and coefficient of thermal expansion than the absorbing material substrate, for improved optical performance and integration into broader optical systems. Alternatively, the stacked substrate 50 can include an optical coating of polymeric, metallic, dielectric materials, or combinations thereof deposited utilizing conventional evaporative or sputtering techniques and processes. Thus, this arrangement provides a composite structure for the directional reflection either to or away from the optical absorbing region and or material.

As shown in FIG. 4, the stacked substrate 50 can include the flat and polished surface 20. Alternatively, the stacked substrate 50 can be located on the opposite side of the substrate 10 from the flat and polished surface 20.

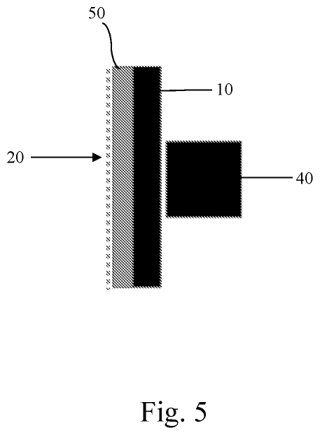

FIG. 5 illustrates an optical component with a stem 40 and a stacked substrate 50 according to another embodiment of the present disclosure. FIG. 5 shows that an optical component can be configured to include both a stem 40 used to mount the optical component and a stacked substrate 50 to provide the all benefits of both of these features described above.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1. An optical component, comprising a substrate, the substrate including a first surface having a surface flatness of λ/4 (peak-valley) wherein the optical component transmits no more than 0.001% of light at 532 nm at an angle of incidence between 45-90°.

2. The optical component of claim 1, wherein the substrate is one-piece including no joints, no seams, or any formerly separate pieces, and made of black quartz.

3. The optical component of claim 1, further comprising a radiation absorbing layer on the substrate.

4. The optical component of claim 3, wherein the radiation absorbing layer includes one of tungsten, tungsten carbide, silicon carbide, black chrome, black oxide, and black paint.

5. The optical component of claim 1, further comprising a stem on a second surface of the substrate.

6. The optical component of claim 5, wherein the stem protrudes from the second surface.

7. The optical component of claim 6, wherein the stem is made of a same material as the substrate.

8. An optical component, comprising:
a substrate; and
a stacked substrate attached to the substrate, wherein
one of the substrate and the stacked substrate includes a surface having a surface flatness of λ/4 (peak-valley), and
the optical component transmits no more than 0.001% of light at 532 nm at an angle of incidence between 45-90°.

9. The optical component of claim 8, wherein the substrate is made of black quartz.

10. The optical component of claim 8, further comprising a radiation absorbing layer on the substrate or the stacked substrate.

11. The optical component of claim 10, wherein the radiation absorbing layer includes one of tungsten, tungsten carbide, silicon carbide, black chrome, black oxide, and black paint.

12. The optical component of claim 8, further comprising a stem attached to the substrate or the stacked substrate.

13. The optical component of claim 12, wherein the stem is made of a same material as the substrate.

14. The optical component of claim 8, further comprising an optical coating on the surface having the surface flatness of λ/4.
